(19) United States
(12) Patent Application Publication
(10) Pub. No.: US 2003/0113397 A1
(43) Pub. Date: Jun. 19, 2003

(54) Compressing device for performing compression operations on shaped bodies made of grainy materials

(76) Inventor: Hubert Bald, Bad Berleburg (DE)

Correspondence Address: ALIX YALE & RISTAS LLP, 750 MAIN STREET, SUITE 1400, HARTFORD, CT, 06103, US

(21) Appl. No.: 10/169,340

(22) PCT Filed: Dec. 27, 2000
(86) PCT No.: PCT/DE00/04632

(30) Foreign Application Priority Data
Aug. 10, 2000 (DE) 100 39 028.5

(51) Int. Cl. B29C 43/04

(52) U.S. Cl. 425/412; 425/416; 425/421

(57) ABSTRACT

The invention relates to a compressing device for performing compression operations on shaped bodies made of grainy materials. The grainy materials, e.g. wet concrete mortar, are formed into shaped bodies in the mold recesses (106) of the mold boxes by applying vibrations and compression pressure. The invention aims at providing a low-noise low-energy consuming compressing device. In order to achieve a low-noise compression operation, said mold box (106) and vibrating table (124) are rigidly clamped together and harmonic vibrating operation of the vibrating mass-spring-system is ensured. Reduced energy use and effective compression is promoted by applying a vibrating frequency, said frequency being at least partially in the range of the resonance frequency of the

The invention relates to a compaction device, operated by means of vibrational oscillations, for the moulding and compaction of moulding materials in moulding recesses of moulding boxes to form mouldings, the mouldings having a top side and an underside via which the compacting forces are introduced. In this method, before the compacting operation, the moulding material is located in the moulding recesses initially as a volume mass of loosely sticking-together granular constituents which are moulded to form solid mouldings only during the compacting operation as a result of the action of compacting forces on the top side and underside. When the compaction device is used in machines for the production of precast concrete products (for example, paving stones), the volume mass may consist, for example, of wet concrete mortar, in foundry moulding machines of moulding sand and in sintered-product moulding machines of metal particles or other sintered particles. In use in sintered-product moulding machines, the compaction device may also be used for the further compaction of preformed sintered-product mouldings.

The invention relates, in particular, to those vibratory compaction devices which operate with comparatively low noise and with low energy consumption for compaction. In this case, low-noise operation requires, on the one hand, that compaction take place by the application of essentially harmonic (sinusoidal) vibrational forces and, on the other hand, that the moulding box has no appreciable characteristic movements in relation to the other components involved in the oscillation. In order to fulfil the last-mentioned requirement, the moulding box must be capable of being clamped relative to such a machine element which participates in the vibrational oscillations. Such a machine element which is appropriate is, for example, the oscillating table located under the moulding box. The requirement for compaction with low energy consumption is fulfilled in that the mass/spring system involved can also oscillate in or at least in the vicinity of the resonant frequency fₒ of this system. In this case, by virtue of what is known as the resonance effect, resonant-frequency operation leads to highly effective compaction due to the very high accelerations capable of being achieved in this case, when it is ensured that the moulding is also subjected to the high values for oscillating acceleration which are derived from resonant operation.

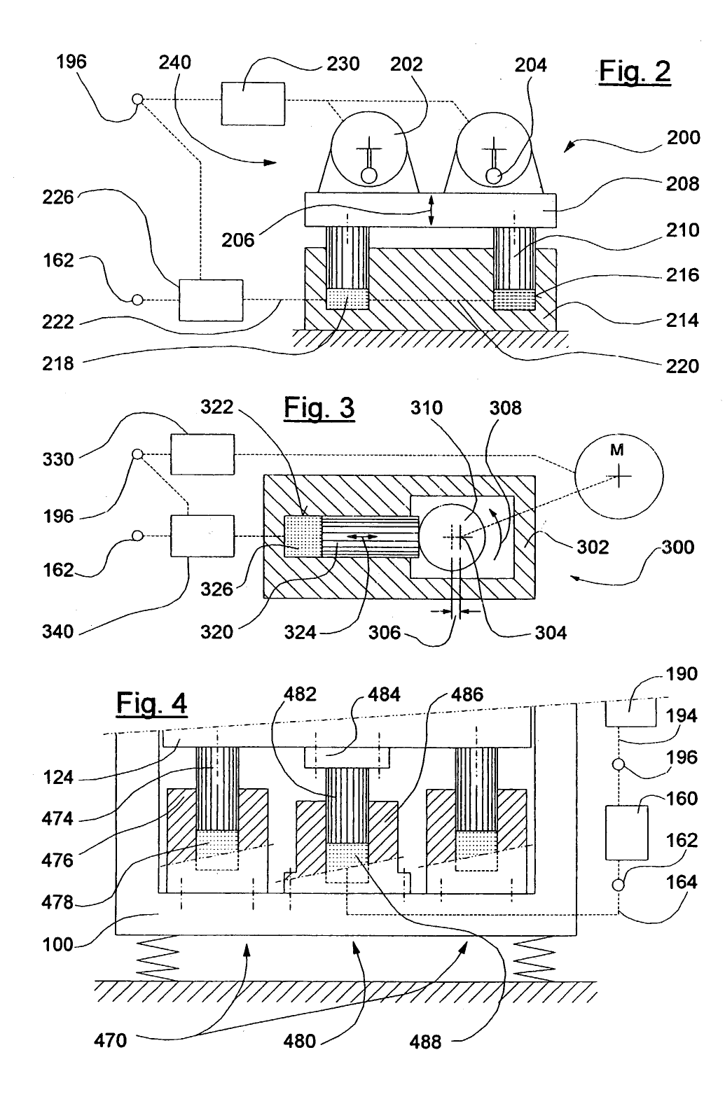

The nearest prior art is demonstrated by the publication EP 0 870 585 A1, and DE 44 34 679 A1 is useful for describing the general state of the art. Since the structural set-up of a compaction device of that generic type to which the invention is attributable is not sufficiently illustrated in EP 0 870 585 A1, the most essential structural features incorporated into the entire force flux of a compaction device according to the invention are listed below with reference to FIG. 2 of DE 44 34 679 A1:

one side, for example the top side, of the moulding 226 is acted upon by a press plate 250, via which press plate the moulding is also acted upon, during the compacting operation, by a special“average press force”, also referred to below for simplification as press force, which press plate can absorb the vibrational forces introduced from the other side (for example, the underside), which press plate can additionally carry out a displacement movement in relation to the other side of the moulding, specifically for the purpose of following it up by the reduction in compaction height during the compacting operation and, if appropriate, also for carrying out the customary necessary movements during the handling of the moulding or moulding box, which press plate is assigned an (if appropriate, hydraulically operated) press-force device 264 for generating the press force and/or for carrying out a displacement movement, and which press plate supports the forces transmitted by it against a frame 204 of the compaction device. [The special“average press force” established here arises, in addition to a constantly transmitted force fraction, above all, from the pulses introduced into the moulding by the baseplate 294 and transmitted by the moulding and by its nature is not a static or continuously acting press force].

The other side, for example the underside of the moulding 226, is acted upon by means of a baseplate 294, in addition to the press force capable of being applied by the baseplate, also by vibrational forces which are generated and introduced by a movement-generating system 240. The baseplate 294 is itself, in turn, supported relative to the oscillating table 211 of the oscillating-mass system.

The movement-generating system 240 is formed by a mass/spring system 207+217 which carries out the vibrational oscillations and the mass of which is defined by an oscillating-mass system 207, and by a drive device for generating the exciting forces for the excitation of oscillations on the oscillating-mass system 207 or on the mass/spring system 207+217.

The oscillating-mass system 207 is supported via springs 217 relative to the frame 204 (or relative to the ground on which the frame bears with its gravitational force). The springs 217 in this case assume both the function of energy storage during the oscillating operation of the oscillating-mass system or of the mass/spring system and the function of supporting the press force. The oscillating-mass system comprises the masses of a plurality of co-oscillating components, inter alia the oscillating table 211, the baseplate 294, the moulding box 213, the moulding/mouldings 226 and the integral parts, intended for co-oscillation, of the clamping device 298 for the moulding box.

The drive device 215 serves for the generation of exciting forces at a predeterminable exciting frequency and assumes the transmission of the exciting energy, which is used for setting in motion and maintaining the oscillations of the mass/spring system, and also for transmitting the compacting energy and that energy which is necessary for covering various frictional-loss energies. The exciting energy to be transmitted is subjected at least once to energy conversion in the drive device by the use of an exciting actuator 238, a first energy form being converted into a second energy form, which second energy form is transferred as exciting energy to the oscillating-mass system.

The support of the vibrational forces or vibrational pulses and of the press force superposed on these is carried out in such a way that all forces or vibrational pulses are carried in a closed force-flux circuit, the frame 204 (and, if appropriate, also the ground) also being incorporated into this force-flux circuit (between the press plate 250 and the springs 217 of the oscillating-mass system). A noteworthy particular feature of the structural set-up of the compaction device according to FIG. 2 of DE 44 34 679 A1 (the significance of which is dealt with once again later) is that the forces conducted by the oscillating table 211 are supported in two different ways (in relation to the frame). Springs 217 transmit the (average) press force and the superposed dynamic mass forces of the oscillating mass/spring system 207+217 and in this case also serve at the same time as a store for the intermediate conversion of kinetic energy of the oscillating oscillating-mass system 207 into spring energy (and vice versa). The hydraulic pistons 228 transmit the exciting forces. The force-flux circuit is in this case therefore led along two parallel paths on the section between the oscillating table 211 and the frame 204. It may also be said that the forces conducted via the springs 216, on the one hand, and the exciting forces, on the other hand, are coupled in parallel to the mass of the mass/spring system 207+217.

It goes without saying that at least some of the force-transmission elements included in the force-flux circuit can form an oscillatable mass/spring system which has at least one first resonant frequency fₒ, which resonant frequency can be excited by the defined exciting frequency of the drive device. In the compaction device DE 44 34 679 A1 in FIG. 2, there is provision (according to column 15, lines 3 to 16) for the mass/spring system 207+217 to be operated at its resonant frequency fₒ. There is no provision, however, for the moulding 226 itself to be included in the mass/spring system oscillating in resonance. On the contrary, the compaction of the moulding 226 is to take place by the action of the impact acceleration arising from impacts between the baseplate 294 and the underside of the moulding or between the end face 272 of the press plate 250 and the top side of the moulding (see, for example, column 3, lines 1 to 21). At the same time, the moulding 226 executes free-flight movements (gap L) in relation to the oscillating-mass system 207 (see, for example, column 9, lines 40 to 52, or Patent Claim 1). What is concerned, therefore, is, as it were, a“shaking compaction device”.

The compaction device described by DE 44 34 679 A1 also differs from the generic type of compaction devices defined by EP 0 870 585 A1 as follows:

It is not possible to carry out a type of compaction in which the mass of the moulding 226 itself is also included in the force-flux circuit of a mass/spring system operated at its resonant frequency fₒ.

In so far as the exciting force is generated by a directional vibrator 118 serving as an exciting actuator and having two unbalanced bodies, although high efficiency is achieved during energy conversion in the actuator itself, there is nevertheless the problem that the exciting force cannot be switched on and off quickly enough. Since, in the operation of the exchange of the finished moulding, to be carried out within the moulding box, for the initially uncompacted loose moulding mass (for the next moulding to be compacted), the oscillating-mass system 207 should not be in motion, the then continuously required acceleration and braking of the directional vibrator would then result in an unused idle time in the manufacturing process and also energy dissipation.

EP 0 870 585 A1 describes a compaction device, in which the compaction of a moulding takes place by simultaneously applying a press pressure and vibration by means of sinusoidal oscillating acceleration. (The following feature designations are, in part, adapted to the terminology used in the explanation of DE 44 34 679 A1. The press pressure can be controlled by a hydraulic press-force device 6 and the vibration (oscillation) is executed by means of a hydraulic/mechanical mass/spring system which is formed by the oscillating table 1, the moulding box 14, the moulding 17, the movable part 2 of the hydraulic exciter 3 and the compressible hydraulic medium which is located between the movable part 2 of the exciter and the drive means 7 (electromechanical control member).

Vibration during compaction may be executed in such a way that the hydraulic/mechanical mass/spring system oscillates in the vicinity of or exactly at its resonant frequency fₒ and at the same time (by means of the accelerations“a”) generates mass forces which are superposed on the press force generated by the hydraulic press-force device 6. It also follows from this that here, in contrast to DE 44 34 679 A1, the press pressure (generated by the hydraulic press-force device 6 and transmitted via the hydraulic cylinder 5, 6) is not a pressure interrupted between two oscillating movements of the hydraulic/mechanical mass/spring system, but, instead, a pressure with a constant fraction and with a changing fraction superposed on the latter.

So that, with regard to the force-flux circuit, also present in this compaction device, for the“resultant forces” (=press force+exciting forces+dynamic mass forces) conducted via the moulding 17 (mass 17), a comparison can be made with the force-flux circuit of the compaction device according to DE 44 34 679 A1, reference is made to the indication, given in EP 0 870 585 A1 (column 2, line 41), as to a compaction device according to EP 0 620 090, in which the “resultant forces” conducted via the moulding 15 (product 15) shown there are supported relative to the frame 1, 2 shown there. It may be inferred from this (this actually also being self-evident to a person skilled in the art) that the “resultant forces” conducted via the moulding 17 in the compaction device according to EP 0 870 585 A1 are incorporated into a force-flux circuit in such a way that the “resultant forces” are supported relative to a “frame to be assumed” via the hydraulic press-force device 6, on the one hand, and via the hydraulic exciter 3, on the other hand. Moreover, a force-flux circuit leading via the “frame to be assumed” is necessarily to be assumed, if only because compressible hydraulic medium embodying the spring of the mass/spring system can generate only forces in one direction (only pressure forces). Consequently, because of the high oscillating frequency sought after, the backswing of the mass of the mass/spring system must additionally be brought about not only by the also coacting gravitational force, but also by means of a force which is supported relative to a frame via the moulding (and via the hydraulic press-force device 6).

It is particularly important, when considering the functioning of the compaction device according to EP 0 870 585 A1, that (in contrast to the compaction device according to DE 44 34 679 A1), the force-flux circuit is led only along a single force-flux path on the section between the oscillating table 1 and the “frame to be assumed”, which force-flux path leads via the movable part 2, the compressible hydraulic medium [which is arranged between the movable part 2 and the drive means 7 or the electrohydraulic control member 7 (column 4, lines 18 to 21)] and the exciter 3. The compressible hydraulic medium is involved in two functions here. On the one hand, it is an integral part of the hydraulic exciter 3, specifically in that the volume of the medium is acted upon by “dynamic hydraulic volume flows” (column 2, lines 38 to 40) with the aid of the drive 7 and of the control means 11, with the result that the movable part 2 of the exciter 3 is forced to execute oscillating movements, and with the result that the exciting/oscillating movement and the dynamic exciting forces are generated (the dynamic volume flows are the fluid volumes added to and taken away again from the volume of the medium at the timing of the exciting frequency). On the other hand, the volume of the medium is an integral part of the hydraulic/mechanical mass/spring system to be set in oscillations at a resonant frequency fₒ, the compressible hydraulic medium being used as a spring (later also called a main system spring).

Consequently, it may also be said that the force-flux path of the “resultant forces” between the moulding 17 and the “frame to be assumed” is led via the functional carrier “movable part 2” as the force-transmitting part of the hydraulic exciter 3 (see also column 1, lines 47 and 48) and via the functional carrier “medium” as a spring of the hydraulic/mechanical mass/spring system, which functional carriers are connected by being linked one behind the other (series connection). The situation is also stated expressly in Patent Claim 1 (column 6, lines 1 to 8), in that it is said that, on the one hand, the hydraulic/mechanical mass/spring system comprises the integral parts “movable part 2” and “compressible hydraulic medium”, and that, on the other hand, the “compressible hydraulic medium” is present between the “movable part 2” and the “drive 7” and is therefore connected to the “movable part 2”. It may be inferred from this that the technical teaching disclosed in EP 0 870 585 A1 proceeds expressly from a series connection of the functional carriers “component transmitting exciting forces” (of the exciter for generating the exciting forces) and “spring of the mass/spring system to be operated at its resonant frequency” or else from a support of the exciting forces relative to the hydraulic medium of the system spring.

The following may also be noted, furthermore, as regards the disclosures of the invention of EP 0 870 585 A1: for the purpose of bringing about and maintaining the oscillations of the hydraulic/mechanical mass/spring system, it is necessary for exciting energy to be supplied in portions at the rate of the exciting frequency. The energy to be supplied while the oscillations are maintained in this case covers the energy losses which are extracted from the system by damping and friction and also by the energy requirement for the compaction of the moulding. According to the disclosed most general ideas of the invention, the supply of the exciting energy is to take place solely hydraulically, specifically in such a way that the exciting energy is discharged in hydraulic form directly to the critical (hydraulically designed) spring member of the system. The supply of the exciting energy in portions takes place, in this case, in that the energy portions are introduced into the oscillating hydraulic/mechanical mass/spring system by means of the “dynamic hydraulic volume flows” to be generated discretely and at the rate of the exciting frequency (column 2, lines 38 to 40). In this case, the energy feed to be carried out in portions may take place logically only by means of the “dynamic hydraulic volume flows” associated with rising pressure. As may be gathered, inter alia, from the remarks in column 1, lines 33 to 50, and in column 3, lines 19 to 22, the “dynamic hydraulic volume flows” are to be generated with the co-operation of an “electrohydraulic control member” or of a “servo mechanism 7, 8”. This special measure for energy feed must therefore have a specific significance in the invention, but this is not described.

In the critical analysis of the operation of a compaction device according to EP 0 870 585 A1, it can be established that precisely the use of the feature of the series connection of the abovementioned functional carriers or the use of the feature of supporting the exciting forces relative to the hydraulic medium of the main system spring, together with the selected and previously cited type of feed of the exciting energy, entails some disadvantages and is therefore open to improvement, in order thereby to reduce the energy consumption and also the production costs.

The problems are also aggravated by the following circumstances: as already stated in EP 0 870 585 A1 (column 3, line 54, to column 4, line 8), and as a person skilled in the art knows, very high frequencies can and are to be generated in a compaction device of this type and, precisely at the high frequencies, the resonance effect, together with its further-increased accelerations, is also to be claimed. However, the dynamic accelerations “a” of the oscillating masses of the mass/spring system or the vibrational forces grow with the square of the frequency. These high dynamic mass forces also have superposed on them the necessary press forces and exciting forces, and the high “resultant forces” occurring as a result must necessarily be conducted via the hydraulic spring and therefore also via the exciter. In practice, this means, with regard to a compaction device according to EP 0 870 585 A1, that the “dynamic hydraulic volume flows” are to be generated by the electrohydraulic control member 7 or by the servo mechanism under the influence and the load of the pressures induced in the medium by the “resultant forces” and, of course, under the load of the high frequencies (up to 100 Hz) provided. Of the problems hidden in the known prior art according to EP 0 870 585 A1 and to be addressed by the present invention, 3 problems will be selected below and considered in more detail:

a) as can be demonstrated for a mass/spring system excited to forced oscillations by means of a predeterminable exciting-force amplitude, using the formula for amplitude amplification as a function of the exciting frequency (which can be represented as a graph by what is known as the resonance curve), for oscillation excitation in the region of the characteristic frequency a considerably lower exciting force is required, as compared with the maximum value of the dynamic oscillating force to be applied by the main system spring. Since the resonance effect may also be claimed precisely in the upper region of the exciting frequency range that can be carried out, and since the maximum values of the dynamic oscillating forces grow with the square of the exciting frequency, very high maximum spring forces are obtained, for which (in the case of a predetermined maximum pressure) the spring cylinder has to be designed in terms of its cylinder cross section. However, with the predetermined oscillating-stroke amplitude, the size of the spring cylinder designed for the oscillating forces also fixes the size of the alternating volumes which are required for excitation and are to be exchanged. As a result of this situation, the exciting actuator must be operated with an unnecessarily large periodic alternating volume flow, the disadvantages of this being not only an increased energy loss, but also the need for the servo device (for example a servo valve) for generating the alternating volumes to have a correspondingly large dimensioning.

b) In the principle of using a common fluid volume for the exciting actuator and the fluidic main system spring, a further source of considerable loss of exciting capacity also arises from the following situation: in a first movement part of the downward oscillating movement, an alternating volume must be discharged from the cylinder space, specifically until that point located approximately in the middle of the total downward oscillating stroke is reached, where the compression space of the fluidic spring has to be closed off sealingly, so that subsequently, in the second movement part of the downward movement, the compression volume can be compressed and consequently the spring function can be implemented. However, the transmission from the first movement part to the second movement part takes place precisely in a situation where the spring piston has developed its highest oscillating velocity. Consequently, in the case of a theoretically optimum volume-flow control, the periodic alternating-volume flow would have to assume its highest value shortly before the transmission from the first movement part to the second movement part, in order immediately thereafter to fall to the value zero. This requirement cannot be fulfilled with real servo valves, particularly at the high frequencies required (of up to 100 Hz). On the contrary, the controlled transmission from a maximum volume flow to the zero volume flow requires a certain amount of time in which the control cross section of the servo valve is reduced, but, because of the maximum reached by the oscillating velocity, a high pressure is built up at the servo valve, which is throttled in the servo valve and which constitutes a considerable energy loss. The energy throttled during this operation must, during the upward oscillating movement, be supplied again to the oscillating system by the exciting actuator, in addition to the exciting energy still otherwise to be supplied (=useful energy and other system-internal lost energy), which, in addition to the energy loss, also means an increase in the outlay in terms of apparatus.

c) A further undesirable effect arises during the use of a common fluid volume for the exciting actuator and for the fluidic main system spring, from the fact that, in the oscillating-stroke phase in which the common cylinder has to serve as an exciting actuator, during the pressure action then necessary on the fluid volume, the spring fluid volume is also compressed, with the result that a spring function (energy storage) develops in the spring fluid volume in an undesirable way, and with the result that the otherwise possible straightforward force excitation of the actuator is coupled to the spring function of the main system spring. This coupling is undesirable, because, inter alia, it causes an additional and also changing phase shift between the exciting force and the oscillating movement. Moreover, as a result of the compression of the spring fluid volume, the alternating volume to be exchanged by means of the servo device is increased, which may amount to 50% of the alternating volume otherwise only required and which, if the expansion of the exciting pressure is not carried out completely, causes throttle losses when the upper oscillating-stroke amplitude is reached during the subsequent volume change and when the downward movement commences.

NL-A-8 004 985 discloses a device for the compaction of granular materials to form mouldings by the introduction of essentially harmonic vibrational forces, in which a mould stationary during compaction is used, in which an upper and a lower press plate, between which the granular material is arranged, are provided movably. The lower press plate is in this case supported on the ground via springs which may also be used for setting the vibration amplitude. The springs do not constitute stores for the kinetic energy of the vibrating mass, so that, correspondingly, there is also no energy recovery. By contrast, the vibration itself is generated solely by the hydraulic pressure for acting upon pistons connected to the press plates.

DE-A-37 24 199 discloses a device for the compaction of granular materials to form mouldings by impact compaction, in which a mould is arranged on an oscillating table insulated relative to the ground via springs and driven via unbalanced masses, above which mould a hydraulically and spring-loaded covering weight is arranged in a frame, all these parts co-oscillating.

The object of the invention, for the respective generic type of compaction devices operating with harmonic compacting forces and with the resonance effect, is to avoid the undesirable effects mentioned or to reduce their action. The solution for achieving the object is described by the two independent Patent Claims 1 and 2. Thus, there is provided: a compaction device for carrying out compacting operations on mouldings (108) composed of granular materials by the introduction of essentially harmonic (sinusoidal) vibrational forces into the moulding to be compacted, with an oscillatable mass/spring system (136) having a main system spring (150, 970) with one or more characteristic frequencies, and with an exciting device (144) which is adjustable in terms of its exciting frequency and by means of which the mass/spring system can be excited to forced oscillations, from which oscillations the vibrational forces are derived, the compaction device furthermore comprising:

a press plate (110) capable of being acted upon by a press force,

an oscillating table (124),

a mould (106) connected firmly to the oscillating table at least during the compacting vibration, in which mould the moulding can be received between the press plate and the oscillating table,

a control (190) for controlling or regulating the exciting device, and the oscillating table being part of the oscillating mass of the mass/spring system, on which oscillating table acts the force of the main system spring and the exciting force generated by an exciting actuator belonging to the exciting device.

According to Patent Claim 1, the above-defined compaction device is characterized, furthermore, in that the main system spring (150, 970) is designed as a hydraulic spring with a compressible fluid volume (140, 906), in that separately acting members are provided for generating the exciting force (135, 980) and the spring force of the main system spring (150, 914), and in that the force-flux paths for the exciting force and the spring force run at least partially separately.

According to Patent Claim 2, the above-defined compaction device is characterized, furthermore, in that the main system spring is designed as a single mechanical spring or as a resultant spring composed of a plurality of mechanical individual springs, in that separately acting members are provided for generating the exciting force (135, 980) and the spring force of the main system spring, and in that the force-flux paths for the exciting force and the spring force of the main system spring run at least partially separately.

Further advantageous refinements of the invention are defined by the subclaims.

The solution for achieving the object is based on the recognition that the problems arising in the prior art can be eliminated by uncoupling both the exciting forces and the spring forces and additionally by separating the members of the exciting function and of the spring function. As a result, the present invention can depart from the hydraulic design of exciter and spring, which seems to be the only possible design from the standpoint of the prior art, and the exciter and spring can advantageously both be designed mechanically and hydraulically in any desired combination. The resulting principle of the possibility of substituting the hydraulic spring by a mechanical spring (and vice versa) is already explained in the independent Patent Claim 2 and also constitutes the common factor linking the two Claims 1 and 2.

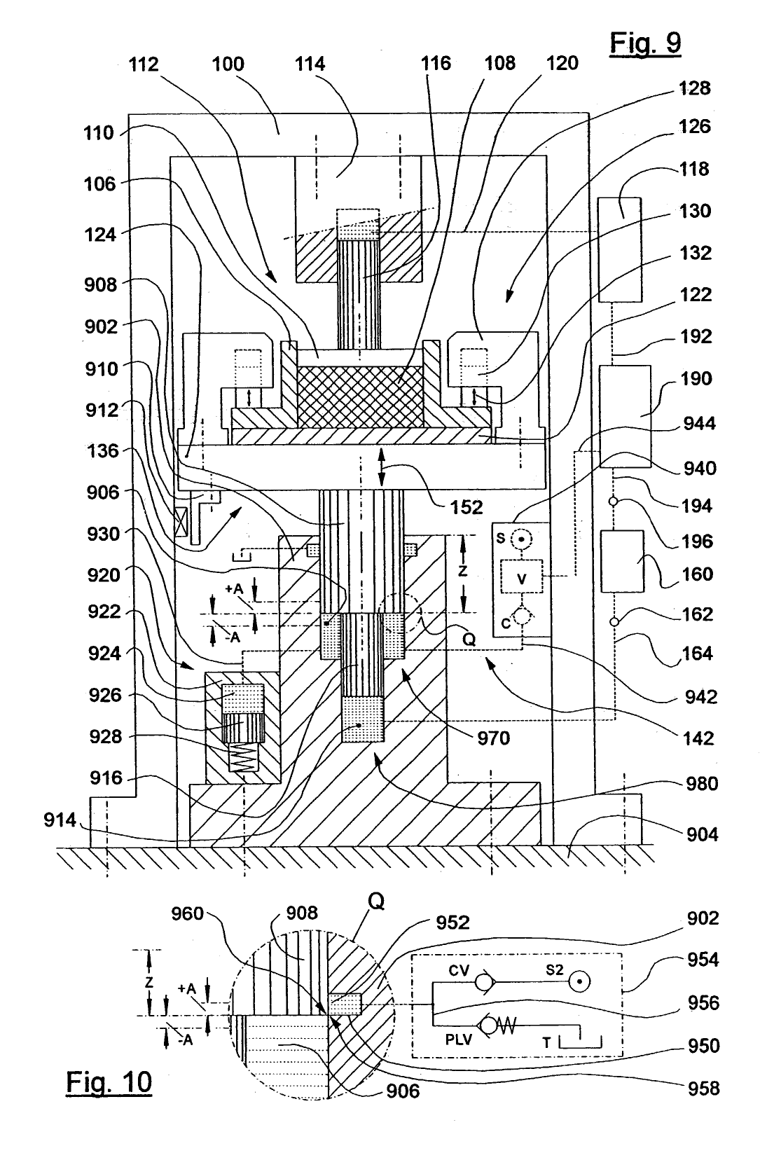

The main advantages of the inventive solution arise from the elimination or reduction of the adverse effects in the prior art, as were described above under points a) to c): high savings of exciting energy and outlay in terms of apparatus for the exciting device are obtained. The control of the entire exciting device is simplified by the uncoupling of spring forces and exciting forces, this being expressed if only by the fact that the generation of the exciting force can now extend over the entire double amplitude (=2A in FIG. 9). Moreover, a superposition of mass forces of the mass/spring system and of exciting forces on a force-flux path leading via the main spring system is not permitted. Instead, the exciting forces are led along a special force-flux path which runs between the oscillating table and the frame, parallel to the force-flux path leading via the main system spring. For the solution according to Patent Claim 1, this means that the exciting force, when it is being generated, is not supported relative to the compressible fluid volume of the main system spring, and, for the solution according to Patent Claim 2, this means that the exciting force, when it is being generated, is not supported relative to the main system spring in such a way that the energy storable by means of the main system spring is increased as a result of the action of the exciting force.

When a hydraulic exciting actuator is used, in a particular refinement of the invention, a hydraulic alternating-volume pumping generator is provided in different variants. In this case, the “dynamic hydraulic volume flows” required for the generating exciting forces or the hydraulic alternating volumes to be exchanged are not generated in that the volume flow derived from a pressure source is modulated or portioned by means of an electrohydraulic control member or a servo mechanism, but, instead, a hydraulic alternating-volume pumping generator is used as part of the exciting device. In the alternating-volume pumping generators provided with a mechanical pump-piston drive, the amounts of the hydraulic alternating volumes to be exchanged are essentially independent of the pressure prevailing in each case in the hydraulic exciting actuator. The alternating volumes ejected from them at their outlet and introduced again are generated by means of pump pistons (or, in general terms, by means of the displacement members of positive-displacement pumps known in principle), the pump pistons (or the displacement members) being moved with predetermined strokes capable of being kept constant preferably by mechanical means, the strokes being derived mechanically from rotating (electric or hydraulic) drive motors.

The possible keeping constant of the strokes during the excitation of the mass/spring system does not rule out the fact that the strokes of the lifting pistons are also variable in the predetermined way or that the alternating volumes are variable as a result of a variation in the useful stroke of the lifting pistons, as, for example, in the case of an axial piston pump regulatable with respect to displacement volume. The alternating volumes introduced into the fluid volume in order to generate the exciting force may also be varied in that, although the stroke of the alternating-volume pumping generator is kept constant, nevertheless only part of the alternating volume corresponding to a pumping stroke is introduced into the fluid volume. As an example of a regulating operation to be implemented in this way, reference is made to the variation of the useful stroke of the lifting pistons in a conventional diesel engine injection device.

The pumping movements of the pump pistons may be generated differently, depending on the type of alternating-volume pumping generators, this being represented by the following examples:

The strokes of the pump pistons may be generated by the vibrational movements of unbalanced vibrators, preferably of directional vibrators, the frequency of the strokes being capable of being varied by means of the rotational speed of the drive motors and the stroke length of the strokes by the known means for varying the oscillating amplitudes of the vibrators.

The strokes of the pump pistons may also be generated and varied, as takes place in hydraulic pumps, for example in radial pumps or axial pumps. As regards the pumps, which in each case have to be modified somewhat, it will be necessary merely to ensure that the ejected alternating volume can also flow back into the acquired cavity of the pump cylinder during the return stroke of a pump piston.

The size of the exchanged alternating volumes remains constant, because the stroke strokes of the alternating-volume pumping generator cannot be influenced retroactively by the influence of the dynamic pressure of the exciting actuator (owing to the dynamic mass forces). Nevertheless, the dynamic pressure of the exciting actuator may have a retroaction on the alternating-volume pumping generator, in that the pump piston is driven by the dynamic pressure on its return stroke, with the result that the average power output of the drive motor of the alternating-volume pumping generator is reduced. Precisely because of this retroactive effect, this type of coupling for the exciting energy also gives rise, under specific conditions, to an automatic synchronization of the exciting frequency and the oscillating frequency of the mass/spring system or automatic synchronization of the phase relationship of the two types of oscillations. The drive motor of the alternating-volume pumping generator merely needs, in this case, to be controlled or regulated in terms of its rotary frequency. Any deviation of synchronization of the phase relationship between the rotary frequency and the oscillating frequency of the mass/spring system is compensated or mitigated in its action by the elasticity of the electrical field, in particular of the rotary field or of the travelling wave of an alternating-current motor (slip).

In order to fulfil the requirement for a rapid switch-on and switch-off of the exciting actuator, in the event that the alternating-volume pumping generator does not have a suitable device for varying the stroke length of the strokes (preferably to the value zero), according to the invention there is provided, between the outlet of the cylinder space of the alternating-volume pumping generator and the inlet of the space closing off the fluid volume of the hydraulic exciting actuator, a switchable member by means of which at least the fluid-volume exchange can be restricted or interrupted. Advantageously, by means of the same switching operation, a bypass path is also to be switchable, via which alternating volumes can be transferred into another vessel.

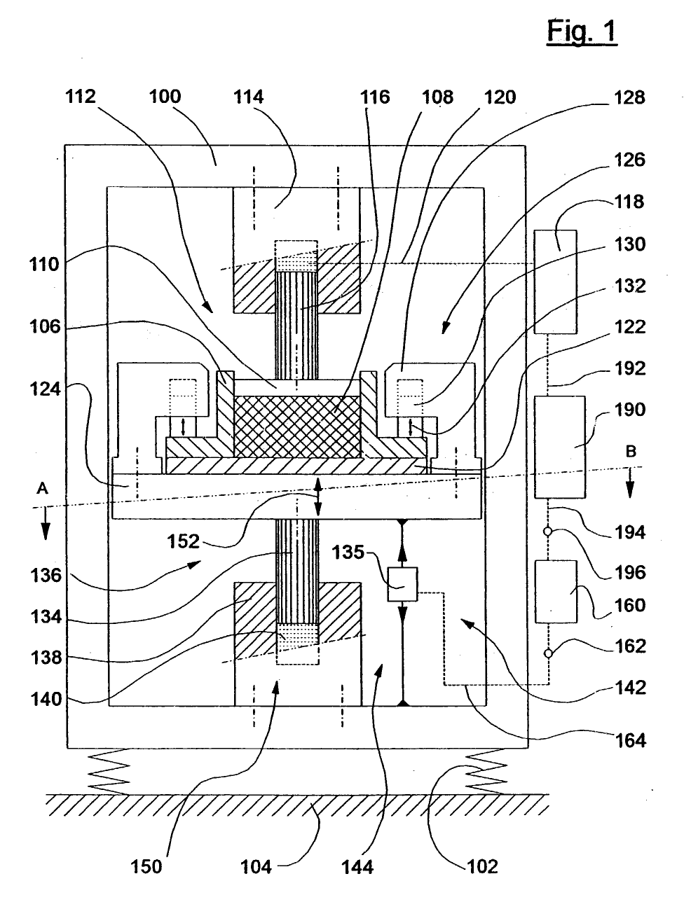

The invention is explained in more detail below with reference to FIGS. 1 to 10.

FIG. 1 shows a compaction device in a general version, the part shown below the line A-B being illustrated in FIGS. 4 to 8 in another special design, so that that part of the compaction device which is shown in FIG. 1 below the separating line A-B is replaced by the part-illustrations of FIGS. 4 to 8.

FIG. 2 illustrates a first variant and FIG. 3 a second variant of an alternating-volume pumping generator which is identified in FIG. 1 as the frame 160, which frame symbolizes in FIGS. 1 and 9 a control part which, together with the exciting actuator, forms the entire exciting device.

FIG. 9 shows a further variant of the compaction device, in which the hydraulic linear motor of the exciting actuator is arranged coaxially with respect to the hydraulic cylinder of the main system spring.

As to FIGS. 2 to 8, it is also applicable to FIG. 9 that the reference symbols commencing with the numeral “1” illustrate the same members or features as in FIG. 1.

FIG. 10 reproduces, on an enlarged scale, a detail identified by Q in FIG. 9, together with a connected hydraulic circuit.

In FIG. 1, 100 designates the frame of the compaction device, which frame has to transmit forces of different kinds and is supported relative to the ground 104 via springs 102 serving as oscillation insulators. Located in an upwardly and downwardly open moulding box 106 is the moulding 108 to be compacted, on the top side of which the press plate 110 of the press device 112 rests. The undersides of the moulding box and of the moulding lie on a baseplate or transport plate 122 which, in turn, rests on the oscillating table 124. Two clamping devices 126 with clamping elements 130 movable in the direction of the double arrow 132 for the purpose of clamping and releasing are provided, in order to allow the baseplate and/or the moulding box to be exchanged. At least during the compacting operation, the moulding box 106 and the baseplate 122 are clamped relative to the oscillating table 124, so that they form a physical unit with the latter.

The hydraulic press device 112 consists of a cylinder 114, of a piston 116 and of a press drive device 118 which is connected via a hydraulic line 120 to the pressure fluid of the cylinder via a line 192 to the central control 190. The press device supports the forces which are transmitted via the press plate 110 relative to the frame. The press drive device 118 may also be designed in such a way that it is connected to a pressure source which keeps a predeterminable pressure constant in the event of differently discharged or received volume flows.

The oscillating table 124, together with other components moved synchronously with it and including mainly the moulding box 106, the clamping device 126, baseplate 122 and oscillating piston 134, belongs to an oscillating-mass system 136 which constitutes the mass of an oscillatable mass/spring system. The dynamic mass forces generated during the execution of the oscillations of the mass/spring system are supported relative to the frame via the main system spring 150. The main system spring of the mass/spring system constitutes at the same time an energy converter and energy store, since it continuously converts the kinetic energy of the oscillating-mass system 136 into spring energy (and vice versa). As regards FIG. 1, the main system spring 150 is embodied by a pressure-fluid volume 140 of specific size Vₒ, at least part of the pressure-fluid volume being restrained between the oscillating piston 134 and the walls of the cylinder 138. The dynamic mass forces are supported relative to the frame 100 via the cylinder 138.

For the purpose of carrying out the compacting operation to be carried out using vibration, the oscillating-mass system 136 can be forced to generate oscillating movements 152. The forces for carrying out the oscillating movements are generated by a movement-generating system 142 (which, in principle, may have a widely differing design). The latter consists at least of the two integral parts, the main system spring 150 which takes over the generation of the main forces and the exciting device 144 for supplying the drive energy for exciting and maintaining oscillations and for the compacting work. The exciting device itself comprises the exciting actuator (illustrated in general in FIG. 1 by a rectangle 135) for generating the exciting forces and the exciter control 160 for the energy supply and energy control of the exciting actuator. The exciter control 160 is indicated diagrammatically by a frame which represents various embodiments. The connection point 196 in the line 194 from the central control 190 to the exciter control 160 and the connection point 162 in the operative connection between the exciter control 160 and the exciting actuator 135 are intended additionally to illustrate the exchangeability of the functional carrier, the exciter control 160.

The exciting actuator 135 is arranged in such a way that it supports the exciting forces by means of a movable part relative to a component of the oscillating-mass system 136, preferably relative to the oscillating table 124, and by means of a fixed part relative to the frame 100 (the movable part and the fixed part are not illustrated in FIG. 1). It is clear that the force-flux paths of the main system spring 150 and of the exciting actuator 135 run at least partially separately, so that a direct coupling of the spring forces and exciting forces, as in the prior art referred to, cannot occur. It can also be seen that the exciting force, when being generated, is not supported relative to the compressible fluid volume 140 of the main system spring 150. The part-illustrations of FIGS. 4 to 8 show that the functional carriers, the main system spring and exciting actuator can be implemented by absolutely different means.

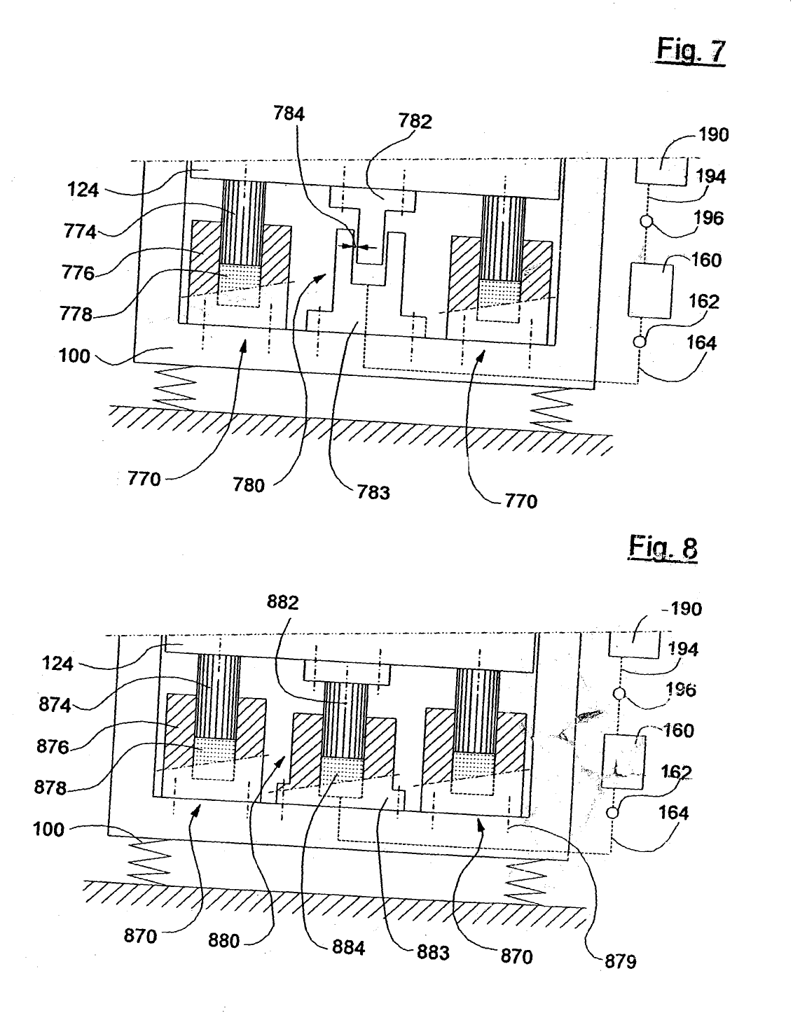

The exciting actuator 135 functions in such a way that energy portions are supplied to it at the rate of the frequency predetermined by the exciter control 160, as illustrated symbolically by the operative connection 164. In the event that the exciting actuator is a hydraulic actuator, for example a hydraulic linear motor, a dynamic exchange of alternating volumes takes place at the predetermined frequency, via the operative connection 164 then to be interpreted as a hydraulic line, between the exciting actuator and an alternating-volume pumping generator present in the exciter control 160. Three different types of alternating-volume pumping generator may be considered, two of which are explained with reference to FIGS. 2 and 3. (In the third variant, the exciting actuator is operated by means of an electric linear motor which works in a similar way to that described under FIG. 7.)

Ideally, the periodic exciting forces are produced at least approximately as harmonic exciting forces. This is achieved in the simplest way by using alternating-volume pumping generators, including an unbalanced vibrator, or by the operation of a hydraulic positive-displacement pump. In principle, the mass/spring system can be excited within defined limits to harmonic oscillations with any desired frequencies and any desired oscillation-stroke amplitudes. This also applies to the case of compacting vibration to be carried out, the oscillations of the mass/spring system in this case also being influenced by the components of the press device 112 and by the moulding 108 itself, for example by its spring force. In all events, the mass/spring system with its exciting device 144 is designed in such a way that, even loaded by the press device with a predetermined press force conducted via the moulding, it can be operated well outside the resonant frequency fₒ, but also at the resonant frequency fₒ or in the vicinity of fₒ (above and below). As is known, resonance operation is also characterized, inter alia, in that, in this case, very high accelerations of the oscillating table are achieved, which are necessary precisely in the case, provided here, of compaction by harmonic vibrational forces, whilst at the same time, in resonance operation, relatively low exciting forces have to be generated.

Should the compaction device be an integral part of a concrete-block machine (the compacted mouldings later hardening into concrete blocks), the moulding, before being compacted, consists of a moulding material composed of loosely sticking-together granular constituents, such as, for example wet concrete mortar. After compaction has ended, the moulding is ejected from the moulding box in a way known per se and transported away, and the empty moulding box is once again filled with uncompacted moulding material in a likewise known way. The press device 112 is also involved in a way known per se in the operation of changing the moulding-box content, in that, in this case, the piston 116, together with the press plate 110, is capable of executing a stroke movement leading upwards and downwards. After the filling of the moulding box 106 with moulding material, the compacting process commences with the press plate 110, moved downwards by the press device, coming to rest on the top side of the moulding material. From this moment of the stroke movement of the press plate 110 onwards, the latter, exerting a predeterminable press pressure on the moulding obtained travels further downwards with the increasing compaction of the latter. With the commencement of compaction brought about by the press plate 110 or beginning or ending at any other time, compaction is carried out by the joint action of press pressure and vibration on the moulding.

Particularly effective compaction may be brought about if vibration is carried out at the resonant frequency or in the vicinity of the resonant frequency fₒ. For this reason, during the compacting operation, a process flow is provided, during which the resonant frequency fₒ is at least once approached or reached or overshot. Since different constituents of the moulding mass, with their different behaviours, often require, during compaction, different vibrational frequencies suitable for them, there is also provision for varying the vibrational frequency and with it, if appropriate, also the oscillation-stroke amplitude during the compacting operation. As compaction progresses, the press force is also optimally to be adaptable. So that a repeatable time profile of the parameters can be maintained, there is therefore provision for causing the size of at least one of the parameters of frequency, oscillation-stroke amplitude or press force, to vary according to a predetermined time function. In a further form of the invention, there is provision for providing, instead of the one resonance point defined mainly by the spring constant of the pressure-fluid volume 140, one further resonance point or a plurality of resonance points by a variation in the spring constant. This requirement can be fulfilled by the specific size Vₒ of the pressure-fluid volume 140 being formed by a plurality of subvolumes capable of being separated from one another by means of switchable shut-off valves. In the case of a desired variation in the spring constant, it is then necessary merely to open or close the corresponding shut-off valves. A continuous variation of the spring constant may also be provided, in that part of the pressure-fluid volume 140 is formed by a cylinder, the cylinder space of which is varied by means of a piston displaceable in the cylinder in a predetermined way. For the purpose of varying the resonant frequency, it is also possible to vary the oscillating mass (when the vibrator is stationary). This may be carried out by additional masses being automatically coupled and uncoupled (not illustrated in the drawing).

The vibration must be capable of being switched on and off for example when the moulding-box content is changed. The switch-on and switch-off of the vibration must be capable of being carried out very quickly with a view to a high productivity of the production plant as a whole. In order to fulfil this requirement, measures are provided, which are described later with reference to further figures.

For the transmission of the force fluxes, the ground 104 could, of course, also be included, as shown in FIG. 9. For the purpose of avoiding vibrations in the ground, however, there is provision, for FIG. 1, for causing the force fluxes of, above all, the dynamic mass forces to flow completely through the frame 100 and for insulating the vibrations of the frame relative to the ground by means of springs 102. It should also be noted that the pistons 116 and 134 in FIG. 1, and also other pistons in the other figures, may be designed as double-acting pistons.

FIG. 2 shows in diagrammatic form an exciter control 200 with an alternating-volume pumping generator, including an unbalanced vibrator 240. Via two connection points 162 and 196, the entire exciter control can be connected to a compaction device according to FIG. 1 at the connection points 162 and 196 likewise present there, the exciter control 200 replacing the exciter control symbolized in FIG. 1 by the frame 160. Two unbalanced masses 204 are forced by their drive motors 202 to rotate synchronously in opposition and thereby offset the baseplate 208 of the common stand in directional oscillation which is indicated by the double arrow 206. Moreover, the baseplate 208. is also supported, soft, relative to the cylinder housing 214 via springs in a way not illustrated in the drawing. Fastened to the baseplate 208 are two pump pistons 210 which co-operate with two cylinder spaces 216 of the cylinder housing 214. The cylinder spaces are connected to one another by means of a connecting line 220 and are connected outwards via a line 222 to the connection point 162, with the apparatus 226 being included. As a result of the oscillating movement of the pump pistons 210, the pressure-fluid volume 218 which is under a prestressing pressure is forced, during each downward stroke, to discharge under increased pressure an exchange volume of predetermined size via the connection point 162 to the pressure-fluid volume of the, in this case hydraulically operating, exciting actuator 135 in FIG. 1 and, during each upward stroke, also to receive again an exchange volume discharged by the pressure-fluid volume of the exciting actuator. With each exchange volume exchanged during a downward stroke, an exactly defined exciting-energy portion can consequently be discharged to the mass/spring system of FIG. 1.

The drive motors 202 are acted upon by a control apparatus 230, by means of which, for example, the rotary frequency can be influenced in such a way that it corresponds to the resonant frequency fₒ of the compaction device of FIG. 1. The control apparatus 230 is also connected, on the other hand, to the central control 190 via the connection point 196. The size of the exchange volume to be exchanged by means of the hydraulically operated exciting actuator 135 in FIG. 1 must be capable of being varied for different reasons, and this must also include the possibility of completely preventing the volume exchange and consequently the oscillating movement of the compaction device. Various solutions are provided according to the invention for this task. On the one hand, the oscillation amplitude of the vibrator can be varied between the value zero and the maximum value by means known per se and not to be described in any more detail here. On the other hand, there is a possibility of restricting or interrupting the fluid-volume exchange between the pressure-fluid volume 218 and the exciting actuator 135. The equipment in terms of apparatus for the last-mentioned measures is to be indicated by an apparatus 226 and its control tie-up to the central control 190 via the connection point 196.

FIG. 3 illustrates in diagrammatic form an exciter control 300 with a hydraulic pump as an alternating-volume pumping generator. Via two connection points 162 and 196, the entire exciter control can be connected to a compaction device according to FIG. 1 at the connection points 162 and 196 likewise present there, the exciter control 300 replacing the exciter control symbolized by the frame 160 in FIG. 1. In a pump casing 302, a circular cam disc 310 can be driven in rotation by means of a drive motor M about a shaft 304 mounted rotatably in the pump casing, as symbolized by the arrow 308. The axis of rotation of the cam disc is arranged outside the centre of the cam circle by the amount of an eccentric distance 306. During the rotation of the cam disc, a pump piston 320 is forced to carry out oscillating movements in the cylinder space 322, as symbolized by the double arrow 324. As a consequence of the oscillating movements of the pump piston 320, the pressure-fluid volume 326, which is under a prestressing pressure, is forced, during each displacement stroke, to discharge under increased pressure an exchange volume of predetermined size via the connection point 162 to the pressure-fluid volume of the exciting actuator 135, assumed to be hydraulically operated in FIG. 1, and, during each return stroke, also to receive again an exchange volume discharged by the pressure-fluid volume of the exciting actuator. With each exchange volume exchanged during a displacement stroke, an exactly defined exciting-energy portion can consequently be discharged to the mass/spring system of FIG. 1.

The drive motor M is acted upon by a control apparatus 330, by means of which, for example, the rotary frequency of the cam disc 310 can be influenced in such a way that it corresponds to the resonant frequency fₒ of the compaction device of FIG. 1. The control apparatus 330 is also connected, on the other hand, to the central control 190 via the connection point 196. So that, in this case too, the size of the exchange volume to be exchanged with the pressure-fluid volume of the exciting actuator in FIG. 1 can be varied, two corresponding possibilities are provided in the exciter control 300. In one solution, the stroke of the pump piston 324 may be varied in that the eccentric distance 306 is varied (this is possible to the value zero). The other solution works in a similar way to the solution described with regard to FIG. 2, in which the fluid-volume exchange between the pressure-fluid volume 326 and the pressure-fluid volume of the exciting actuator can be restricted or interrupted. In this case, the apparatus 340 performs the same task as the apparatus 226 in FIG. 2.

FIG. 4 shows a variant of a compaction device according to FIG. 1 with the oscillating table 124, in which variant the exciting actuator 480 for generating the exciting forces and the main system spring 470 are designed differently, as compared with a compaction device according to FIG. 1 with a hydraulic exciting actuator. In FIG. 4, the main system spring 470 is embodied by the individual springs of two pressure-fluid volumes 478 of identical size, which are enclosed in each case between a specific oscillating piston 474 and a cylinder 476. The exciting actuator 480 is formed by the actuator piston 482, which is fastened to the oscillating table 124 by means of the piston holder 484, by the actuator cylinder 486 and by the actuator pressure-fluid volume 488 which is connected to the exciter control 160 by means of the operative connection 164. As already described with regard to FIG. 1, in FIG. 4, too, alternating-volume pumping generators (which can take the place of the symbolic frame 160 between the connection points 162 and 196), such as, for example, those described by FIGS. 2 and 3, are also to be capable of being used as exciter controls. As in the compaction device in FIG. 1, in FIG. 4 the transmission of the exciting forces takes place in such a way that they are led between the oscillating table 124 and frame 100 along a particular force-flux path which runs parallel to the force-flux paths leading via the individual springs (478). Owing to this measure, a coupling of exciting forces and dynamic mass forces in one and the same pressure-fluid volume cannot occur.

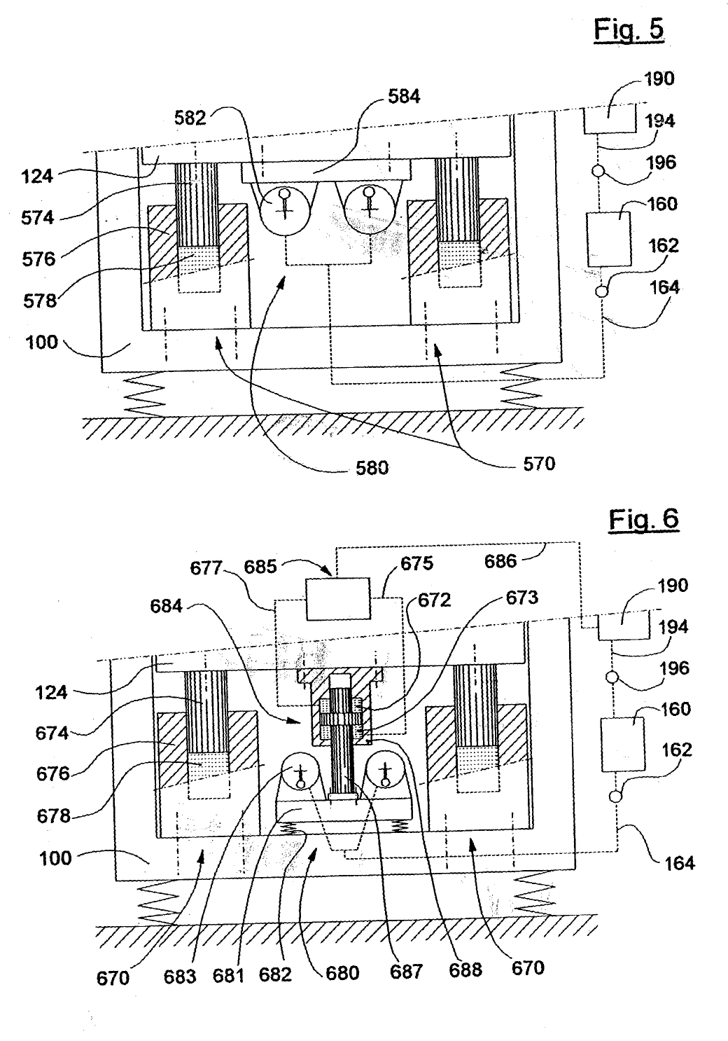

FIG. 5 shows a variant of a compaction device according to FIG. 1 with the oscillating table 124, in which variant the exciting actuator 580 for generating the exciting forces and the main system spring 570 are designed differently, as compared with FIG. 1. In FIG. 5, the main system spring 570 is embodied by two pressure-fluid volumes 578 of identical size, which are enclosed in each case between a specific oscillating piston 574 and a cylinder 576. The exciting actuator 580 is formed by a directional vibrator 584 of adjustable amplitude, which is fastened directly to the oscillating table 124 without a force-transmitting connection to the frame 100. The two drive motors 582, via which the rotational speed can also be controlled, are activated via the operative connection 164 by means of the exciter control 160. The same as was described in the description relating to FIG. 4 applies in a somewhat similar way to the transmission of the exciting forces along a specific force-flux path.

FIG. 6 shows a variant of a compaction device according to FIG. 1 with the oscillating table 124, in which variant the exciting actuator 680 for generating the exciting forces and the main system spring 670 are designed differently, as compared with FIG. 1. In FIG. 6, the main system spring 670 is embodied by two pressure-fluid volumes 678 of identical size, which are enclosed in each case between a specific oscillating piston 674 and a cylinder 676. The exciting actuator 680 comprises, on the one hand, a directional vibrator 681 which is supported, soft, relative to the frame 100 via springs 682. The two drive motors 683, via which the rotational speed can also be controlled, are activated via the operative connection 164 by means of the exciter control 160. The directional vibrator 681 does not, in this case, have to be adjustable in terms of its oscillation amplitude and may remain constantly in oscillation. The switch-on and switch-off of the exciting forces generated by the directional vibrator on the oscillating table 124 and the control of the size of the exciting-energy portions to be transmitted during each oscillating movement of the directional vibrator are carried out by means of a hydraulically operated coupling device 684 likewise also belonging to the exciting actuator, in conjunction with a hydraulic switching member 685, the latter being activated by the central control 190 via the line 686.

The hydraulic coupling device 684 comprises a double-acting piston 687 which is displaceable up and down in the cylinder space of the cylinder 688 as a result of the oscillating movements of the directional vibrator to which it is fastened. During the oscillation of the directional vibrator 681, alternating volumes, which are parts of the pressure-fluid volumes of the two cylinder spaces 672 and 673 separated by the piston, are exchanged by means of the hydraulic switching member 685. The hydraulic switching member 685 may be operated in various versions: in a first operating mode, it makes a short-circuit path for the alternating volumes to be exchanged, so that, during the upward and downward movement of the piston 687, virtually no exciting forces are transmitted to the oscillating table by the directional vibrator. In a second operating mode, the hydraulic switching member 685 makes available a (preferably continuously adjustable) narrowed short-circuit path having a predeterminable throttle action. By the throttling of the volume flows of the alternating volumes to be exchanged, the transmittable amplitudes of the oscillating movement of the directional vibrator and the transmittable exciting forces or the transmittable exciting-energy portions are reduced in a predeterminable way. In a third operating mode, the short-circuit path is shut off completely, the result of this being that the oscillating movements or the exciting forces of the directional vibrator are transmitted with full amplitude or in maximum size to the oscillating table 124. What was described in the description relating to FIG. 4 applies in a somewhat similar way to the transmission of the exciting forces along a specific force-flux path.

FIG. 7 shows a variant of a compaction device according to FIG. 1 with the oscillating table 124, in which the exciting actuator 780 for generating the exciting forces and the main system spring 770 are designed differently, as compared with FIG. 1. In FIG. 7, the main system spring 770 is embodied by two pressure-fluid volumes 778 of identical size, which are enclosed in each case between a specific oscillating piston 774 and a cylinder 776. The exciting actuator 780 is an electric linear motor consisting of a movable part 782 and of a stationary part 783. The exciting forces are generated in an air gap 784 by means of magnetic alternating fields and are supported, on the one hand, relative to the oscillating table 124 and, on the other hand, relative to the frame 100. The size of the exciting forces, the stroke amplitude of the movable part and the exciting frequency are determined by the exciter control 160 which is connected to the linear motor via the operative connection 164. What was described in the description relating to FIG. 4 applies in a somewhat similar way to the transmission of the exciting forces along a specific force-flux path. In the case of an electric linear motor, it may also advantageously be claimed that a direct conversion of electrical energy into exciting energy can thereby be carried out.

FIG. 8 shows a variant of a compaction device according to FIG. 1 with the oscillating table 124, in which variant the exciting actuator 880 for generating the exciting forces and the main system spring 870 are designed differently, as compared with FIG. 1. In FIG. 8, the main system spring 870 is embodied by two pressure-fluid volumes 878 of identical size, which are enclosed in each case between a specific oscillating piston 874 and a cylinder 876. The exciting actuator 880 is a hydraulic linear motor consisting of a movable part 882 designed as a piston and of a stationary part 883 designed as a cylinder. The exciting forces are generated in the pressure-fluid volume 884 by the exchange of dynamic hydraulic alternating volumes via the operative connection 164 by means of the exciter control 160. In this case, the exciter control 160 contains an electrohydraulic servo mechanism which generates dynamically hydraulic alternating volumes of predeterminable frequency and size and with predeterminable exciting-energy portions according to the control information obtained from the central control 190. The exciting forces are supported, on the one hand, relative to the oscillating table 124 and, on the other hand, relative to the frame 100. What was described in the description relating to FIG. 4 applies in a somewhat similar way to the transmission of the exciting forces along a specific force-flux path.

FIG. 9 shows a variant of a compaction device which works, in a similar way to the variants according to FIGS. 4 and 8, with a hydraulic spring and with a hydraulic exciter. The set-up of the entire compaction device is similar to that of FIG. 1. The reference symbols commencing with the numeral 1 therefore designate the same features, with the functions assigned to them, as in FIG. 1. The features which are different, as compared with FIG. 1, and which commence with the numeral 9 are all arranged below the oscillating table 124. The force flux of all the forces involved passes via the cylinder part 902. The cylinder part, like the downwardly open frame 100, is connected firmly to the foundation 904. The foundation may, in this case, be considered as part of the frame 100 and is likewise a carrier of the force-flux paths of all the compacting forces involved.

The cylinder part 902 contains cylinder spaces or fluid volumes for two different hydraulic linear motors: the compressible fluid volume 906 constitutes the energy-storing part of the main system spring 970 and, with its compression module, is critical for the resonant frequency of the mass/spring system with the oscillating-mass system 136 which also includes the oscillating piston 908. The fluid volume 906, together with the oscillating piston 908, forms the main system spring 970. The actuator fluid volume 914, together with the actuator piston 916 and with the cylinder part 902, forms the hydraulic linear motor of the exciting actuator 980, which linear motor generates the exciting forces by means of which the frequency and amplitude of the compacting vibration are determined. The oscillating piston is connected firmly to the oscillating table 124 and the actuator piston is connected firmly to the oscillating piston. The fluid volume 906 and the actuator fluid volume 914 could also be interchanged.

The exciting actuator 980 is connected to the exciter control 160 by means of the operative connection 164. The exciter control (which may take the place of the symbolic frame 160 between the connection points 162 and 196) may be designed as an alternating-volume pumping generator; it may, however, also contain an electrohydraulic servo mechanism which, on the one hand, is connected to a pressure source (preferably with an essentially constant pressure) and, on the other hand, exchanges dynamically hydraulic-alternating volumes of predeterminable frequency and size and with predeterminable exciting-energy portions with the linear motor.

The oscillating table 124 or the oscillating piston is to be held at an average height predeterminable with a variable or constant value, as symbolized by the dimension “Z”. In the execution of oscillating movements, the average height may be defined, for example, by that oscillation-stroke reference position in which the oscillation velocity has its maximum value and the oscillation acceleration the value zero. With respect to this oscillation-stroke reference position, oscillation-stroke amplitudes +A and −A (associated with positive and negative oscillation accelerations) can be defined, and the oscillation-stroke amplitudes +A and −A may have appreciably different values as a function of various parameters. At least during the execution of oscillating movements in resonance operation, in the case of a negative oscillation-stroke amplitude −A the fluid volume 906 is to be compressed by about the amount −A.

In the execution of an oscillating movement in the positive direction (in the direction of the oscillation-stroke amplitude +A), it may happen that, when a compression amount=zero of the fluid volume is reached, the oscillation-stroke amplitude “+A” is not yet reached. In order, in this case, to avoid the formation of a vacuum, there is provision for the use of a compensating-volume dispenser 920. The latter consists of a cylinder housing 922, a compensating piston 926, a compensating spring 928 and a compensating volume 924 and is connected to the fluid volume 906 via a line 930. While a compression amount>zero of the fluid volume prevails, the compensating piston 926 is pressed into a mechanically formed end position counter to the force of the compensating spring 928. During an upward oscillating movement, the compensating piston is displaced out of its end position by the force of the compensating spring, at the latest when a compression amount=zero of the fluid volume 906 occurs, with the result that a volume flow flows from the compensating volume 924 into the fluid volume 906. Conversely, after the compression amount rises again after the reversal of the oscillating movement at its uppermost point, a volume flow is displaced from the fluid volume 906 into the compensating volume 924, specifically until the compensating piston is again in the end position depicted, with the result that then (leakage losses being disregarded) compression of the fluid volume 906 simultaneously commences again. In another design variant, however, a compensating-volume dispenser could also be replaced by a correspondingly controlled valve which, during the upward stroke, obtains the volume flow from a pressure source and, during the downward stroke, returns the volume flow into the pressure source itself or into another vessel.

An stroke-measuring system is provided for detecting the oscillation-stroke of the oscillating table 124 or of the oscillating piston 908, said system consisting of a first sensor part 910 and of a second sensor part 912. The result of this stroke measurement is supplied to the central control 190 (in a way not illustrated in the drawing) and is processed there. So that the oscillating table 124 or the oscillating piston 908 can be held at the predeterminable average height or oscillation-stroke reference position in spite of leakage losses and other disturbing factors which occur, a hydraulic regulating-volume dispenser 940 is provided. The latter, via the line 942, can introduce a regulating-volume flow into the fluid volume 906 and, if appropriate, also discharge it from the latter, in such a way that the predetermined average height is kept constant. In the example selected, the regulating-volume dispenser 940 has a pressure source S, a check-valve C and a valve V, by means of which valve the necessary metering of the regulating-volume flow is carried out. The valve V, which is activated by the central control 190 via the operative line 944, is an actuator of a closed control loop of a levelling device, by means of which the average height or oscillation-stroke reference position is regulated continuously to a predetermined value.

A compaction device according to FIG. 9 affords several advantages, specifically

the main system spring 970 is not loaded by the exciting forces or the actuator fluid volume is not loaded by the forces of the main system spring. Although the force flux of all three forces involved is combined in the oscillating piston, nevertheless, because the exciting forces are generated separately in a specific exciting actuator, no superposition of exciting forces and of spring forces derived from the dynamic mass forces occurs in the exciting actuator.

In the dimensioning of the actuator cylinder, there is no need to take account of the dimensioning of the oscillating piston which, above all in resonance operation, has to generate forces of a different order of magnitude.

In contrast to the compaction device according to FIG. 8, in FIG. 9 the hydraulic linear motor of the exciting actuator and the spring cylinder of the main system spring are arranged concentrically and at the same time also centrally symmetrically to the oscillating table 124. Owing to the possible symmetrical force application of dynamic mass forces originating from the spring function and of exciting forces, therefore, no jamming effect can occur at the pistons involved, and compaction acceleration acts symmetrically on the entire moulding box 106, this being important, above all, when the moulding box is divided into a large number of individual moulds.

FIG. 10 shows the detail marked by the circle “Q” in FIG. 9, with a modification such that an annular groove 950, which is filled with a fluid volume 952, is provided in the inner cylinder of the cylinder part 902. When an oscillating piston 908 is displaced into a higher position, the fluid volume 952 can combine with the fluid volume 906. Moreover, an additional hydraulic circuit 954 is also shown, the line part 956 of which is connected to the fluid volume 952 via a fluid line 962. FIG. 10 shows, overall, a purely mechanically/hydraulically operating variant, different from FIG. 9, of a levelling device, by means of which the average height or oscillation-stroke reference position of the oscillating table 124 is regulated to a value predetermined by the position of the cylinder control edge 958 of the annular groove and in which the function of the compensating-volume dispenser described in FIG. 9 is also implemented at the same time. The oscillating piston 908 has, on its underside, a piston control edge 960 which, at the same height (as depicted) as the cylinder control edge 958, separates the fluid volume 952 from the fluid volume 906. The oscillation-stroke reference position of the oscillating table 124 is also defined by the depicted height of the oscillating piston. In this case, the cylinder control edge 958 constitutes a dimensional embodiment of the desired position of the oscillation-stroke reference position. The hydraulic circuit works as follows: PLV is a pressure-limiting valve which opens the way into the vessel T for a volume flow at a pressure>p_{L} in the line part 956. S2 represents a fluid source with a constant pressure<p_{L}. A check valve CV prevents a backflow of fluid from the line part 956 into the fluid source.

The levelling device functions as follows: after the piston control edge 960 has passed the oscillation-stroke reference position during a downward oscillating movement of the oscillating piston 908, with the fluid volume 906 separated, the compression of this fluid volume commences and the oscillating movement reaches its lower reversal point after covering the distance −A. As soon as the piston control edge 960 has passed the oscillation-stroke reference position once again during the upward oscillating movement which is subsequently initiated, a compensating volume flow begins to flow from the source S2 into the fluid volume 906, specifically until the oscillating piston 908, after covering the distance +A, has reached the upper reversal point. During the following downward stroke, after a pressure>p_{L} has built up in the fluid volume 906, a volume flow flows from the fluid volume 906 via the pressure-limiting valve PLV into the vessel T, specifically until the piston control edge 960 has passed the oscillation-stroke reference position again. During this travel, the upward strokes corresponding to the distance +A by means of the energy portions supplied via the actuator piston can be of any size within a defined scope.

The same function of this levelling device could also be carried out, in the case of a similar form of construction, with a version of a somewhat different type: in this case, the piston control edge (960) is not formed on the oscillating piston 908 and the cylinder control edge 958 is not formed on the inner cylinder belonging to the oscillating piston 908. Instead, the piston control edge (960) is implemented on another piston and the cylinder control edge 958 on another inner cylinder belonging to the other piston, the cylinder control edge on the other cylinder likewise being implemented by the lower plane face of another annular groove (or by radial bores). The other inner cylinder also contains another fluid volume (similar to 906 in FIG. 10) as a spring medium, which is contiguous to the underside of the other piston. Another hydraulic circuit, set up in the same way as the circuit 954 in FIG. 10, is likewise present, but the other hydraulic circuit is connected with its fluid line (like the fluid line 962) to the other fluid volume, whilst the fluid volume contained in the other annular groove is connected to the fluid volume 906 (=spring medium) by means of a line. Care must be taken, in the version of a different type, to ensure that the other piston is likewise connected to the oscillating table 124 and co-oscillates synchronously with the oscillating piston 908.

The following statements also apply to the design variants of the invention which have been described: the members of the exciting actuator and of the main system spring are at the same time arranged either above or below the oscillating table. Instead of a single moulding or casting-mould model, a plurality may be provided at the same time. The relative position of the main system spring and of the exciting actuator may be interchanged, which would mean, for example as regards FIG. 9, that 908 is the actuator piston and 916 is the oscillating piston. In general terms, it is applicable to all the figures that the dot-and-dash lines show there, such as, for example, the line 879 in FIG. 8, symbolize a firm connection between two components.

1. Device for the compaction of granular materials to form mouldings (108) by the introduction of essentially harmonic vibrational forces, with
an oscillatable mass/spring system (136) with one or more characteristic frequencies, comprising a main system spring (150, 970) for continuous conversion between kinetic energy of the mass/spring system (136) and spring energy, and a mass which has an oscillating table (124), on which the spring force of the main system spring (150, 970) acts, and a mould (106) connected firmly to the oscillating table (124) at least during compaction and intended for receiving the mouldings (108),
an exciting device (144) which is adjustable in terms of its exciting frequency, with an exciting actuator for exciting the mass/spring system (136) to forced oscillations, from which the vibrational forces can be derived,
the exciting force generated by the exciting actuator acting on the oscillating table (124), and the exciting frequency for the oscillations being either at the characteristic frequency or in the vicinity of the latter or being adjustable through a frequency range within which at least one characteristic frequency lies,
a control (190) for controlling or regulating the exciting device (144),
a press plate (110) for acting with force upon the mouldings (108) in the mould (106),
the main system spring (150, 970) being a hydraulic spring with a compressible fluid volume (140, 906),
the forces transmitted by the press plate (110), on the one hand, and the forces transmitted by the main system spring (150, 970), on the other hand, being supported relative to a frame (100), through which forces involved in the compaction are led along a closed force-flux path,
characterized
in that the exciting actuator (144) and the main system spring (150, 970) are designed to be separate from one another and the force-flux paths of the exciting force and of the spring force run at least partially separately.

2. Device for the compaction of granular materials to form mouldings (108) by the introduction of essentially harmonic vibrational forces, with
an oscillatable mass/spring system (136) with one or more characteristic frequencies, comprising a main system spring (150, 970) for continuous conversion between kinetic energy of the mass/spring system (136) and spring energy, and a mass which has an oscillating table (124), on which the spring force of the main system spring (150, 970) acts, and a mould (106) connected firmly to the oscillating table (124) at least during compaction and intended for receiving the mouldings (108),
an exciting device (144) which is adjustable in terms of its exciting frequency, with an exciting actuator for exciting the mass/spring system (136) to forced oscillations, from which the vibrational forces can be derived,
the exciting force generated by the exciting actuator acting on the oscillating table (124), and the exciting frequency for the oscillations being either at the characteristic frequency or in the vicinity of the latter or being adjustable through a frequency range within which at least one characteristic frequency lies,
a control (190) for controlling or regulating the exciting-device (144),
a press plate (110) for acting with force upon the mouldings (108) in the mould (106),
the forces transmitted by the press plate (110), on the one hand, and the forces transmitted by the main system spring (150, 970), on the other hand, being supported relative to a frame (100), through which forces involved in the compaction are led along a closed force-flux path,
characterized
in that the exciting actuator (144) and the main system spring (150, 970) are designed to be separate from one another and the force-flux paths of the exciting force and of the spring force run at least partially separately, the system spring (150, 970) being designed as a single mechanical spring or as a resultant spring composed of a plurality of mechanical individual springs.

3. Device according to claim 1 or 2, characterized in that a force transmission member (908) is provided between the main system spring (970) and the oscillating table (124), and the force transmission member cannot be loaded by the spring force of the main system spring at least over part of the oscillation stroke covered during the execution of the upper oscillation-stroke amplitude (+A), with the result that a free-run stroke(+A) of the force transmission member is defined,
a special volume-exchange device (920) being provided when a hydraulic main system spring (970) is used for filling or emptying the cylinder volume (+A) capable of being generated by the free-run stroke (+A) of the spring piston (908), the spring piston (908) being assigned to the force transmission member or being identical to the latter,
and a lift-off of the force transmission member from the single spring or from the resultant spring being provided when a mechanical main system spring is used.

4. Device according to one of claims 1 to 3, characterized in that, of the kinetic energy of the mass of the mass/spring system, only the kinetic energy of the downwardly directed oscillation velocity is provided for conversion into a spring energy of the main system spring.

5. Device according to one of claims 1 to 4, characterized in that the dynamic spring forces are introduced into the oscillating table at a central point of the latter via the force transmission member (908), and,
in the event that only one exciting actuator is provided, the exciting forces are introduced into the oscillating table via the same force transmission member (908), and
in the event that two or more exciting actuators are provided, the exciting forces are introduced into the central point in terms of their resultant force vector.

6. Device according to claim 5, characterized in that the force transmission member (908) connected to the oscillating table is at the same time an integral part of a guide device (902; 908), by means of which the mass of the oscillating table is forced to execute only vertical translational movements (152), and, in the event that only one exciting actuator is provided, both the dynamic spring forces and the exciting forces are transmitted by that part of the force transmission member which is at the same time part of a guide device.

7. Device according to claim 6, characterized in that an exciting actuator (980) is provided, the exciting forces of which are transferred to the oscillating table (124) by means of only one drive member (916), and in that both the dynamic spring forces and the exciting forces are transmitted by that part of the force transmission member (908) which is at the same time an integral part of a guide device (902; 908).

8. Device according to one of claims 1 to 7, characterized in that the spring constant of the main system spring is adjustable.

9. Device according to one of the preceding claims 1 to 8, characterized in that the press force can be generated variably by means of a press device (112), the press device being controlled or regulated by means of a central control (190).

10. Device according to claim 3, characterized in that when using a hydraulic main system spring (970) with a spring fluid volume (906) a levelling device (940) is provided, by means of which a predeterminable average height (Z) of the oscillating piston (908) is set or regulated.

11. Device according to claim 10, characterized
in that the predeterminable average height (Z) is regulated by the supply of a regulating-volume flow to and/or the discharge of a regulating-volume flow from the spring fluid volume (906) and by the inclusion of the measurement result of a measuring device for determining the actual value of the height (Z), a hydraulic device (940), by means of which the size and/or direction of the regulating-volume flow is varied, being controlled or regulated as a function of the measurement result, or
in that the predeterminable average height (Z) is set by the co-operation of a control edge (958) as the mechanical dimensional embodiment of the height, the control edge, together with another mechanical control feature (960) designed as an edge or face, being used as part of a hydraulic device for varying a volume-flow cross section, the variation in a volume-flow cross section being carried out by means of a relative movement, derived from the oscillating movement, of the control edge (958) and control feature (960), and the compression of the spring fluid volume (906) being initiated when a volume-flow cross section=zero is reached.

12. Device according to claim 10 or 11, characterized in that a compensating-volume dispenser (920) for delivering a compensating volume is used for increasing the spring fluid volume (906) of the hydraulic main system spring (970) during the execution of an upward oscillating movement (in the direction of the amplitude +A).

13. Device according to one of claims 1 to 12, characterized in that a hydraulic exciting actuator is provided, which is capable of being acted upon by alternating volumes, alternating volumes being capable of being generated by means of an alternating-volume pumping generator (160) assigned to the exciting device,
either by a pump piston (210), the pumping movement of which is derived mechanically from the oscillating movement of an unbalanced vibrator (240),
or by a pump piston (320), the pumping movement of which is derived mechanically from a rotating drive member (310),
or by a pump piston, the pumping movement of which is derived from the movement of the movable part of an electric linear motor.

14. Device according to one of claims 1 to 9, characterized in that the exciting forces are forces which are derived from the mass forces of an unbalanced vibrator and which are introduced by the unbalanced vibrator into the mass of the oscillating table (124), specifically either in that the stand of the unbalanced vibrator (584) is connected directly and rigidly to the mass of the oscillating table (124) or in that the unbalanced vibrator (681) is supported, softly (low resonance), relative to the frame (100) or relative to the ground via springs (682), and in that the transmission of the oscillating movements and exciting forces from the unbalanced vibrator to the mass of the oscillating table takes place, with a coupling device (684) incorporated, which coupling device is equipped with one of the principles, listed below, for making a coupling connection, specifically
by mechanical coupling,
utilizing magnetic forces,
using viscous media with electrically switchable shear forces,
hydraulically by the use of one or two restrained oil columns, the oil columns restrained in cylinder spaces (672, 673) being displaceable or non-displaceable as a result of the co-operation of a hydraulic switching member (685).

15. Device according to one of claims 1 to 9, characterized in that the exciting forces are supported between the mass of the oscillating table (124), on the one hand, and the frame (100), on the other hand, and in that the exciting actuator (780) is an electric linear motor (782, 783).

16. Device according to claim 1, characterized in that the main system spring (140) is embodied by a pressure-fluid volume (140) restrained at least partially in a cylinder body, and in that the spring constant can be varied by means of the variation in the size of the pressure-fluid volume,
either in that the size of the pressure-fluid volume (140) is formed by a plurality of subvolumes capable of being separated from one another by means of switchable shut-off valves,
or in that part of the pressure-fluid volume (140) is restrained in a cylinder, the cylinder space of which can be varied by means of a piston displaceable in the cylinder in a predetermined way, the displacement of the piston being carried out preferably by means of a threaded-spindle drive.

17. Device according to one of claims 1 to 16, characterized in that a hydraulic linear motor is provided as the exciting actuator (980), and in that the hydraulic linear motor is arranged centrally symmetrically to the oscillating table (124) and, when the main system spring is designed as a hydraulic spring (970), concentrically to the latter.

18. Device according to one of claims 1 to 17, the compaction device being part of a foundry moulding machine, characterized by the combination of the following features,
the granular material is provided for the function of taking a mould of a casting-mould model,
at least one casting-mould model is accommodated in the mould and is connected to the mass of the mass/spring system firmly and so as to co-oscillate with the latter,
the granular material which is to be compacted and which is to be moulded at least on its underside by the contours of the casting-mould model is arranged next to and/or above the casting-mould model even before the compacting operation.

19. Device according to one of claims 1 to 18, characterized in that the compaction system is part of a sintered-product moulding machine.
